(19) United States
(12) Patent Application Publication
(10) Pub. No.: US 2007/0147791 A1
(43) Pub. Date: Jun. 28, 2007

(54) Moving image reproducing apparatus

(75) Inventor: Reiko Kawachi, Nishitama-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/635,519

(22) Filed: Dec. 8, 2006

(30) Foreign Application Priority Data
Dec. 26, 2005 (JP) 2005-373505

(51) Int. Cl. H04N 7/26

(52) U.S. Cl. 386/112

(57) ABSTRACT

According to one embodiment, a moving image reproducing apparatus which reproduces content including a plurality of streams compressed according to a plurality of CODECs, the moving image reproducing apparatus comprises a display section which generates and outputs a display signal for displaying in list form configurations of a plurality of Audio CODECs in a plurality of audio streams and a setting of each Audio CODEC included in content extracted by an extracting section, an input section which receives a selection of a set of an audio stream, an Audio CODEC, and a setting of the Audio CODEC by a selection on the list displayed, and a reproducing section which carries out a reproducing operation according to the selection of the set received by the input section.

### CROSS-REFERENCE TO RELATED APPLICATIONS

This application is based upon and claims the benefit of priority from Japanese Patent Application No. 2005-373505, filed Dec. 26, 2005, the entire contents of which are incorporated herein by reference.

### BACKGROUND

1. Field

One embodiment of the invention relates to a moving image reproducing apparatus which reproduces moving image information recorded on an information recording medium, such as a disc.

2. Description of the Related Art

US 2006/0044976 A1 has disclosed a method of enabling Dolby sound to be reproduced automatically without selecting Dolby sound by, for example, menu setting in reproducing an optical disc with DTS (Digital Theater System) content by means of an optical disc reproducing apparatus incompatible with DTS sound.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of a moving image reproducing apparatus according to an embodiment;

FIG. 2 is an exemplary diagram to explain the function of Playlist;

FIG. 3 is an exemplary diagram showing object mapping of Title Timeline;

FIG. 4 is an exemplary diagram showing directories and files in a disc;

FIG. 5 is an exemplary diagram showing a configuration of Advanced Content;

FIG. 6 an exemplary diagram showing a description of Playlist;

FIG. 7 is an exemplary diagram showing a configuration of Primary Video Set;

FIG. 8 is an exemplary diagram showing a configuration of Video Title Set Enhanced Video Object Attribute Table (VTS_EVOB_ATRT);

FIG. 9 is an exemplary diagram showing a configuration of VTS_EVOB_ATRT Information (VTS_EVOB_ATRTI);

FIG. 10 is an exemplary diagram showing a configuration of VTS_EVOB_ATR Search Pointer (VTS_EVOB_ATR_SRP);

FIG. 11 is an exemplary diagram showing a configuration of Video Title Set Enhanced Video Object Attribute (VTS_EVOB_ATR);

FIG. 12 is an exemplary diagram showing a configuration of EVOB type (EVOB_TY);

FIG. 13 is an exemplary diagram showing a configuration of Number of Main Audio streams of EVOB (EVOB_AMST_Ns);

FIG. 14 is an exemplary diagram showing a configuration of Main Audio Stream Attribute Table of EVOB (EVOB_AMST_ATRT);

FIG. 15 is an exemplary diagram showing a configuration of EVOB_AMST_ATR;

FIG. 16 is an exemplary diagram showing a configuration of Down-mix coefficient table for Audio streams of EVOB (EVOB_DM_COEFTS);

FIG. 17 is an exemplary diagram showing a configuration of EVOB_DM_COEFT;

FIG. 18 is an exemplary diagram showing a configuration of Number of Sub Audio streams of EVOB (EVOB_ASST_Ns);

FIG. 19 is an exemplary diagram showing a configuration of Sub Audio streams attribute table of EVOB (EVOB_ASST_ATRT);

FIG. 20 is an exemplary diagram showing a configuration of EVOB_ASST_ATRT;

FIG. 21 is an exemplary diagram showing a configuration of Number of Sub-picture streams of EVOB (EVOB_SPST_Ns);

FIG. 22 is an exemplary operation flowchart for a user selecting process;

FIG. 23 is an exemplary diagram showing a selection window;

FIG. 24 is an exemplary diagram showing the selection window displayed when a disc on which only Primary Main Audio/Video has been recorded is loaded;

FIG. 25 is an exemplary diagram showing a main screen when a disc on which only Primary Audio/Video has been recorded is loaded;

FIG. 26 is an exemplary diagram showing an icon displayed on the main screen; and

FIG. 27 is an exemplary diagram showing a case where an updated stream is highlighted for identification.

### DETAILED DESCRIPTION OF THE INVENTION

Various embodiments according to the invention will be described hereinafter with reference to the accompanying drawings. In general, according to one embodiment of the invention, a moving image reproducing apparatus reproduces content including a plurality of streams compressed according to a plurality of CODECs. The moving image reproducing apparatus comprises a display section which generates and outputs a display signal for displaying in list form configurations of a plurality of Audio CODECs in a plurality of audio streams and a setting of each Audio CODEC included in content extracted by an extracting section, an input section which receives a selection of a set of an audio stream, an Audio CODEC, and a setting of the Audio CODEC by a selection on the list displayed, and a reproducing section which carries out a reproducing operation according to the selection of the set received by the input section.

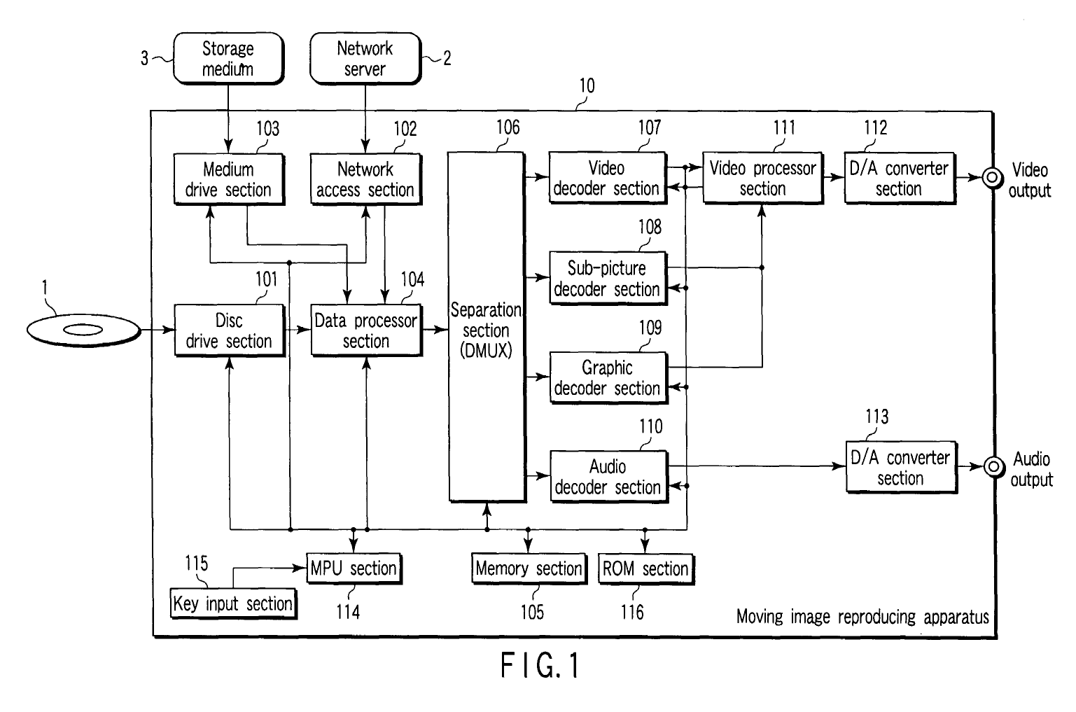

As shown in FIG. 1, a moving image reproducing apparatus 10 according to an embodiment reads the image information stored on an information storage medium, such as a disc 1 complying with the HD-DVD standard, and reproduces the moving image information. The disc 1 is loaded in a disc drive section 101. The disc drive section 101 rotates the loaded disc 1 and reads the information stored in the disc 1 using an optical pickup (not shown).

The moving image reproducing apparatus 10 further includes a network access section 102. The network access section 102 can access a network server 2 configured on a network, such as the Internet, as needed, and acquire information from the network server 2. The moving image reproducing apparatus 10 further includes a medium drive section 103. The medium drive section 103 can access a detachable storage medium 3, such as a USB memory/HDD loaded in the medium drive section 103 or a memory card, and read information from the storage medium 3.

The information read by the disk drive section 101 and the information acquired as needed by the network access section 102 and/or medium drive section 103 are supplied to a data processor section 104, which subjects those pieces of information to an error correction process and then stores the resulting information in a buffer (not shown) in the data processor section 104. Of the information stored in the buffer, management information, which will be described in detail later, is stored in a memory section 105 and is used for reproduction control, data management, and the like. Moreover, of the information stored in the buffer, the moving image information is transferred to a separation section 106, which separates the information into video, graphic units, audio, and sub-pictures. The video information is supplied to a video decoder section 107, the sub-picture information is supplied to a sub-picture decoder section 108, the graphic unit information is supplied to a graphic decoder section 109, and the audio information is supplied to an audio decoder section 110. The individual decoder sections decode the supplied information. Here, sub-pictures are such images as subtitles.

The main video information decoded by the video decoder section 107, the sub-picture information decoded by the sub-picture decoder section 108, and the graphic information decoded by the graphic decoder section 109 are supplied to a video processor section 111, which superimposes those types of information. The superimposed information is converted into an analog signal by a D/A (digital-to-analog) converter section 112, which outputs the analog signal as a video signal to a video display unit (not shown) (e.g., a CRT, a liquid-crystal display, or a plasma display). The audio information decoded by the audio decoder section 110 is converted into an analog signal by a D/A converter section 113, which outputs the analog signal as an audio signal to an audio playback unit (not shown) (e.g., a speaker).

A series of reproducing operations performed on the disc 1, network server 2, and storage medium 3 are controlled comprehensively by an MPU section 114 serving as a control section. The MPU section 114 receives operation information from a key input section 115 and controls the individual sections on the basis of the program stored in the ROM section 116.

Here, the contents dealt with by the moving image reproducing apparatus 10 of the present embodiment will be explained.

There are two types of content: Standard Content and Advanced Content. Standard Content is composed of navigation data and video object on a disc. This is an extension of the DVD-Video standard version 1.1. Advanced Content is composed of Advanced Navigation data (including Playlist, Manifest, Markup, and Script files), Advanced data (including Primary/Secondary Video Set), and Advanced Element (including images, audio, and text). For Advanced Content, at least one Playlist file and one Primary Video Set have to be placed on the disc 1. The other data may be placed on the disc or taken in from the network server 2 or storage medium 3. The Advanced Content realizes not only the expansion of audio and video achieved by the Standard Content but also higher interactivity.

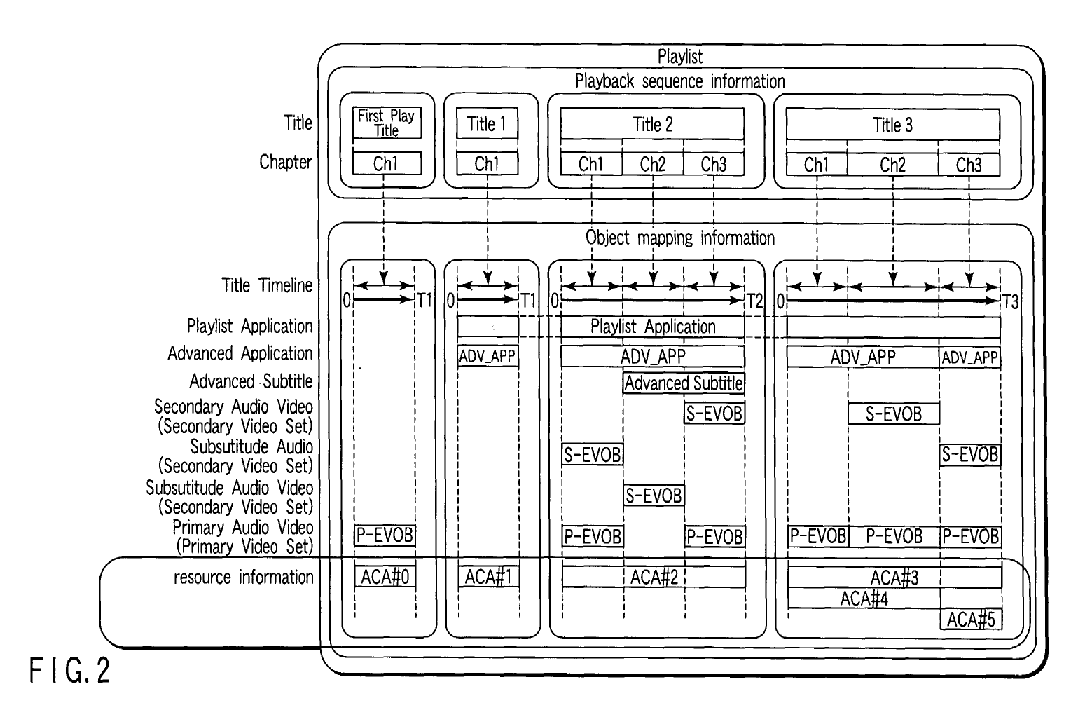

The Playlist is written in XML and recorded on the disc 1. Where there is Advanced Content on the disc 1, the moving image reproducing apparatus 10 executes the Playlist first. As shown in FIG. 2, the Playlist provides the following information:

Object Mapping Information: Information in a title for presentation objects mapped on Title Timeline

Playback Sequence: Playback information for each title written to Title Timeline

When the first application includes Primary/Secondary Video Set, the first application is executed according to the description of the Playlist, referring to these Video Sets. An application is composed of Manifest, Markup (including content/styling/timing information), Script, and Advanced data. The first Markup file, Script file, and other resources constituting an application are referred to in Manifest. With the Markup, the reproduction of Advanced data, including Primary/Secondary Video Set, and Advanced Element is started.

The Advanced data belongs to the data type of Presentation data for Advanced Content. The Advanced data can be divided into the following four types:

Primary Video Set

Secondary Video Set

Advanced Element

Others

The Primary Video Set is a set of data for primary video. The Primary Video Set is composed of Navigation data (including Video Title Set Information (VTSI) and Time Map (TMAP)) and presentation data (including Primary Enhanced Video Object (P-EVOB)). The Primary Video Set is stored onto the disc 1. The Primary Video Set can include various types of presentation data. Conceivable presentation stream types are Main Video, Main Audio, Sub Video, Sub Audio, and Sub-picture. The Primary Video Set can hold one Main Video stream, one Sub Video stream, eight Main Audio streams, and eight Sub Audio streams. The moving image reproducing apparatus 10 can reproduce not only Primary Video and Primary Audio but also Sub Video and Sub Audio. In the middle of reproducing Sub Video and Sub Audio, the Sub Video and Sub Audio in the Secondary Video Set cannot be reproduced.

The Secondary Video Set is used in adding video/audio data to Primary Video Set or in adding only audio data. The Secondary Video Set is recorded onto the disc 1 or is taken in as one or more files from the network server 2 or storage medium 3. The file is stored temporarily in a file cache before reproduction, when data has been recorded on the disc 1 and it has to be reproduced together with the Primary Video Set. In contrast, when the Secondary Video Set is on the network server 2 at a web site or the like, it is necessary to store all of the data temporarily into a file cache (downloading) or store a part of the data into a streaming buffer continuously (streaming). The stored data is reproduced simultaneously without buffer overflow, while the data is being downloaded from the network server 2.

Specifically, the Secondary Video Set is a set of data for network streaming and the previously downloaded content on the file cache. The Secondary Video Set, which has a simplified structure of the Advanced VTS, is composed of Time Map (TMAP) and presentation data (or Secondary Enhanced Video Object (S-EVOB)). The Secondary Video Set can include Sub Video, Sub Audio, complementary audio, and complementary subtitle. The complementary audio is used as substitute audio stream replacing the Main Audio in the Primary Video Set. The complementary subtitle is used as substitute subtitle stream replacing the Sub-picture in the Primary Video Set. The data format of the complementary subtitle is an Advanced Subtitle.

The Advanced Element is presentation materials used to create various types of files generated by a presentation engine or received from a data source, such as a graphic plane, sound effects, or Advanced Navigation data. The usable data formats are:

Image/Animation
PNG
JPG
MNG

Audio
WAV

Text/Font
UNICODE format, UTF-8 or UTF-16
Open font

The Advanced data further includes text files for a game score created in a script in the Advanced Navigation data or cookies received when the Advanced Content accesses a specific network server 2. Some of these data files are treated as Advanced Element, depending on their type, such as an image file read in reproducing Primary Video under the instruction of the Advanced Navigation data.

In the Playlist, Object Mapping Information, Playback Sequence, and configuration information have been written as described above.

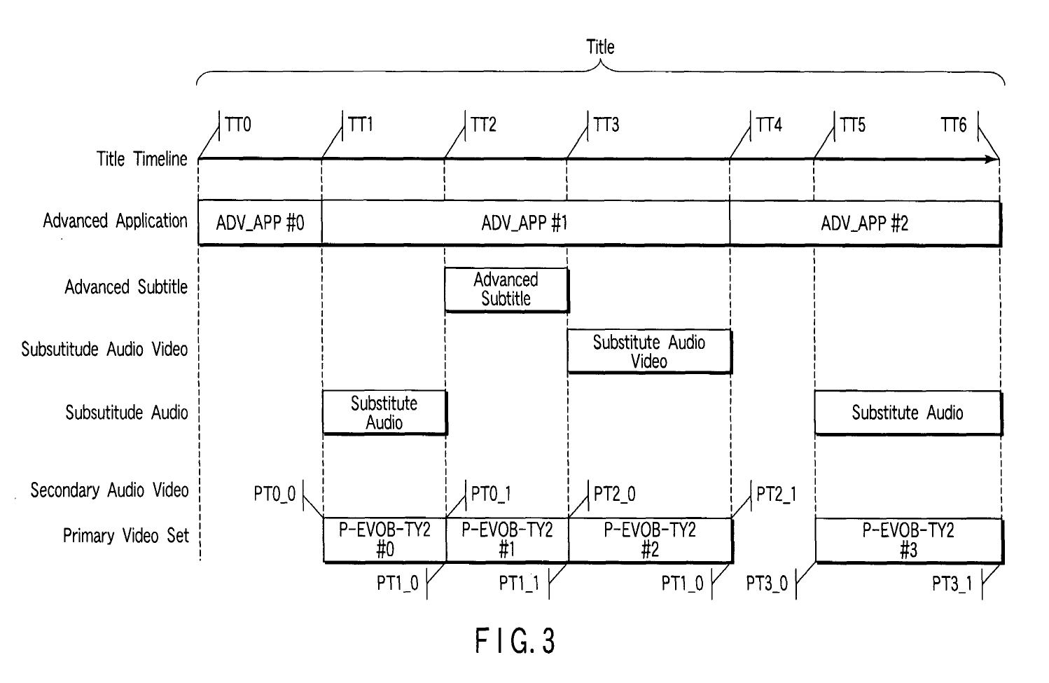

In the Object Mapping Information, the Title Timeline defines the timing relationship between a default Playback Sequence and presentation objects on a title basis. As for a scheduled presentation object, such as Advanced Application, Primary Video Set, or Secondary Video Set, its operating time (from the start time to end time) is allocated to the Title Timeline in advance. FIG. 3 is an exemplary diagram showing an object mapping of the Title Timeline. As the Title Timeline advances, each presentation object starts and ends its presentation. When the presentation object is synchronized with the Title Timeline, the operating time of the previously allocated Title Timeline becomes equal to its presentation time. PT1_0 indicates the presentation start time of P-EVOB-TY2 #1 and PT1_1 indicates the presentation end time of P-EVOB-TY2 #1.

Restrictions are placed on the object mapping of Secondary Video Set, Substitute Audio, and Substitute Subtitle. Two or more of presentation objects of these three types are not permitted to be mapped simultaneously on the Title Timeline.

Moreover, the Playback Sequence defines the starting position of a chapter using the time value of the Title Timeline. To the ending position of the chapter, the starting position of the next chapter or the end of the title line of the last chapter is applied.

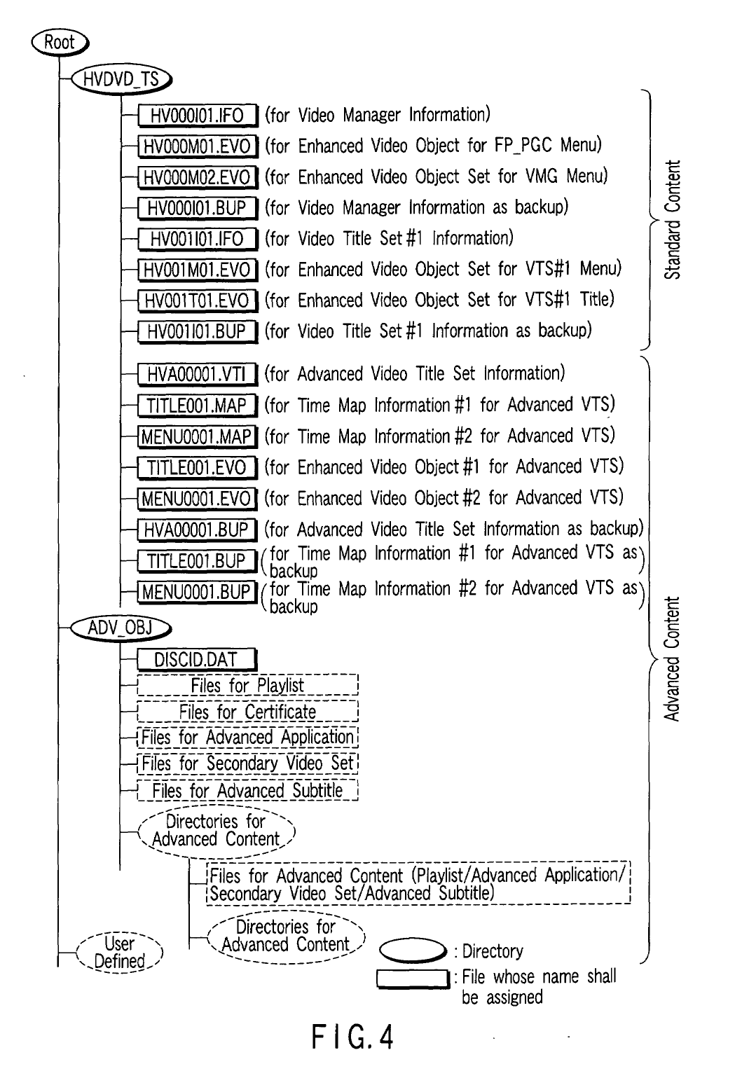

Next, the files and directories related to the disc 1 complying with the HD-DVD standard will be explained with reference to FIG. 4.

Just below the root directory, HVDVD_TS directory and ADV_OBJ directory exist.

HVDVD_TS directory includes all of the files related to one video manager (VMG), one or more Standard VTS's (Standard Video Title Sets), and one Advanced VTS (Primary Video Set).

The files related to one video manager (VMG) include one Video Manager Information (VMGI), one Enhanced Video Object for First Play Program Chain Menu (FP_PGCM_EVOB), and one Video Manager Information as backup (VMGI_BUP). When the size of one Enhanced Video Object Set for Video Manager Menu (VMGM_EVOBS) is 1 GB (=230 bytes) or more, the object set must be divided in such a manner that the number of files is 98 at a maximum under HVDVD_TS directory. Any of the files in one VMGM_EVOBS has to be allocated consecutively.

One Video Title Set Information (VTSI) and one Video Title Set Information as backup (VTSI_BUP) are recorded as Standard VTS configuration files under the HDDVD_TS directory. When the size of one Enhanced Video Object Set for Video Title Set Menu (VTSM_EVOBS) and that of Enhanced Video Object Set for Title (VTSTT_VOBS) are 1 GB (=230 bytes) or more, they has to be divided into up to 99 files so that the size of any file may be smaller than 1 GB. These files are configuration files under the HVDVD_TS directory. As for these files composed of one VTSM_EVOBS and one VTSTT_EVOBS, it is necessary to allocate any file consecutively.

Advanced Video Title Set (Advanced VTS) includes one Video Title Set Information (VTSI) and one Video Title Set Information as backup (VTSI_BUP) as configuration files. Each of one Video Title Set Time Map Information (VTS_TMAP) and one Video Title Set Time Map Information as backup (VTS_TMAP_BUP) can be composed of up to 99 files under the HDDVD_TS directory. When the size of Enhanced Video Object Set for Title (VTSTT_VOBS) is 1 GB (=230 bytes) or more, it has to be divided into up to 99 files so that the size of any file may be smaller than 1 GB. These files are configuration files under the HVDVD_TS directory. As for these files in one VTSTT_EVOBS, it is necessary to allocate any file consecutively.

The following rule is applied to the file names and directory names under the HVDVD_TS directory:

1) Directory name

Let a DVD-video fixed directory name be HVDVD_TS.

2) Video manager (VMG) file name

Let Video Manager Information fixed file name be HV000I01.IFO.

Let Enhanced Video Object for FP_PGC Menu fixed file name be HV000M01.EVO.

Let Enhanced Video Object Set for VMG Menu file name be HV000M%%.EVO.

Let Video Manager Information as backup fixed file name be HV000I01.BUP.

In “%%,” 02 to 99 are allocated consecutively in ascending order to the individual Enhanced Video Object Sets for VMG Menu.

3) Standard Video Title Set (Standard VTS) file name

Let Video Title Set Information file name be HV@@@I01.IFO.

Let Enhanced Video Object Set for VTS Menu file name be HV@@@M##.EVO.

Let Enhanced Video Object Set for Title file name be HV@@@T##.EVO.

Let Video Title Set Information as backup file name be HV@@@I01.BUP.

“@@@” are three characters which are allocated to files of Video Title Set numbers and are in the range from 001 to 511.

In “##,” 01 to 99 are allocated consecutively in ascending order to the individual Enhanced Video Object Sets for VTS Menu or to the individual Enhanced Video Object Sets for Title.

4) Advanced Video Title Set (Advanced VTS) file name

Let Video Title Set Information file name be HVA00001.VTI.

Let Enhanced Video Object Set for Title file name be TITLE0&&.EVO.

Let Time Map information file name be TITLE0$$.MAP.

Let Video Title Set Information as backup file name be HAV00001.BUP.

Let Time Map Information as backup file name be TITLE0$$.BUP.

In “&&,” 01 to 99 are allocated consecutively in ascending order to Enhanced Video Object Set for Title.

In “$$,” 01 to 99 are allocated consecutively in ascending order to the Time Map information.

On the other hand, under the ADV_OBJ directory, all of the Playlist files are placed. Any of Advanced Navigation data files, Advanced Element files, and Secondary Video Set files can be placed under this directory.

Each Playlist file can be placed by the file name of “PLAYLIST%%.XML under the ADV_OBJ directory. In “%%,” 00 to 99 are allocated consecutively in ascending order. The highest-numbered Playlist file is processed first (when the disc is loaded).

In the ADV_OBJ directory, directories for Advanced Content are placed as sub-directories. The Advanced Content directory can be placed only under the ADV_OBJ directory. In the Advanced Content directory, Advanced Navigation data files, Advanced Element files, and Secondary Video Set files can be placed. The directory name is composed of d characters and dl characters. Let the sum total of sub-directories (excluding the ADV_OBJ directory) under the ADV_OBJ be less than 512. Let the depth of directory hierarchy be 8 or less.

Suppose the sum total of Advanced Content files under the ADV_OBJ directory is limited to 512×2047 and the sum total of files in each directory is less than 2048. The file name is composed of d characters and d1 characters. The file name is made up of the body, “.” (period), and an identifier.

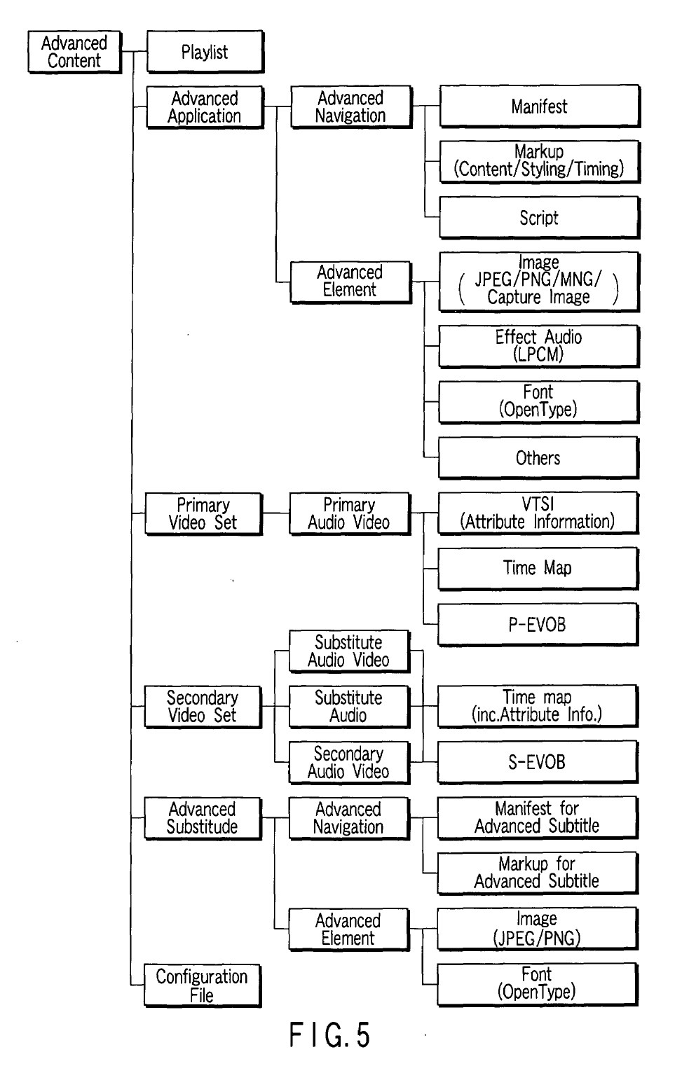

Advanced Content is not necessarily stored in a disc 1 and may be supplied from a network server 2 or a storage medium 3. As shown in FIG. 5, the Advanced Content is composed of Playlist file, Advanced Application, Primary Video Set, Secondary Video Set, Advanced Subtitle, and Configuration File.

The Advanced Application is composed of Advanced Navigation data which manages Image, Effect Audio, Font, and others, and Advanced Element made up of these data managed by the Advanced Navigation data. The Advanced Navigation data includes Manifest files, Markup files, and Script files.

The Primary Video Set is composed of Primary Audio Video which includes Video Title Set Information (VTSI), Time Map (TMAP), and Primary Enhanced Video Object (P-EVOB).

The Secondary Video Set is composed of Substitute Audio video which includes a Time Map and a Secondary Enhanced Video Object (S-EVOB), a Substitute Audio, and a secondary audio video.

The Advanced Subtitle is composed of Advanced Navigation data which manages Image and Font and Advanced Element made up of these data managed by the Advanced Navigation data. The Advanced Navigation data includes Manifest files and Markup files.

In the Configuration File, information about the initial system configuration of the moving image reproducing apparatus 10, including data buffer alignment, is written.

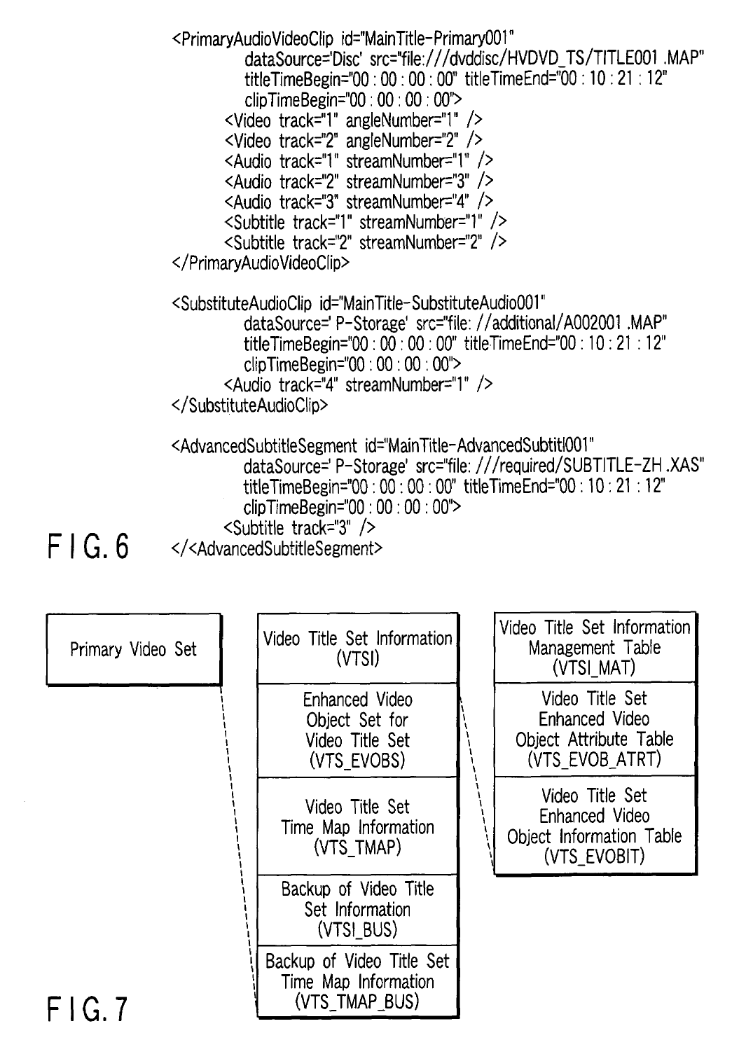

In the Playlist file, information about the titles for Advanced Content can be written. In the Playlist file, a set of Object Mapping Information and the Playback Sequence of each title is written title by title as shown in FIG. 6.

On the basis of a Time Map for reproducing a plurality of objects in a specified period on the timeline, the Playlist file controls the reproduction of a menu and title composed of the plurality of objects. Use of the Playlist enables a dynamic menu to be reproduced.

For example, FIG. 6 shows that the Primary Audio Video, Substitute Audio, and Advanced Subtitle can be reproduced in the period between 00:00:00:00 (the start time of the title) and 00:10:21:12. FIG. 6 further shows that the Primary Audio Video is reproduced according to what has been written in the Time Map information of the file name TITLE001.MAP under the HDDVD_TS directories of the disc 1. It is written in the example of FIG. 6 that the Primary Audio Video has two video tracks, three audio tracks, and two subtitle tracks.

As shown in FIG. 7, the Primary Video Set consists of Video Title Set Information (VTSI), Enhanced Video Object Set for Video Title Set (VTS_EVOBS), Video Title Set Time Map Information (VTS_TMAP), backup of VTSI (VTSI_BUS), and backup of VTS_TMAP (VTS_TMAP_BUS). The VTS_TMAP, which corresponds to the Time Map of FIG. 5, includes address and size information. The Time Map of FIG. 5 exists for each VOB.

In the Video Title Set Information (VTSI), information for a Video Title Set is described. According to this information, attribute information of each EVOB can be described. As shown in FIG. 7, the VTSI starts with Video Title Set Information Management Table (VTSI_MAT), followed by Video Title Set Enhanced Video Object Attribute Table (VTS_EVOB_ATRT) and Video Title Set Enhanced Video Object Information Table (VTS_EVOBIT) in that order. Each table shall be aligned on the boundary between the Logical Blocks. For this purpose each table may be followed by up 2047 bytes (containing 00h).

The Video Title Set Information Management Table (VTSI_MAT) is a table in which the size of VTS and that of VTSI, the start address of each information in the VTSI, the attributes of EVOBS in the VTS, and others are described.

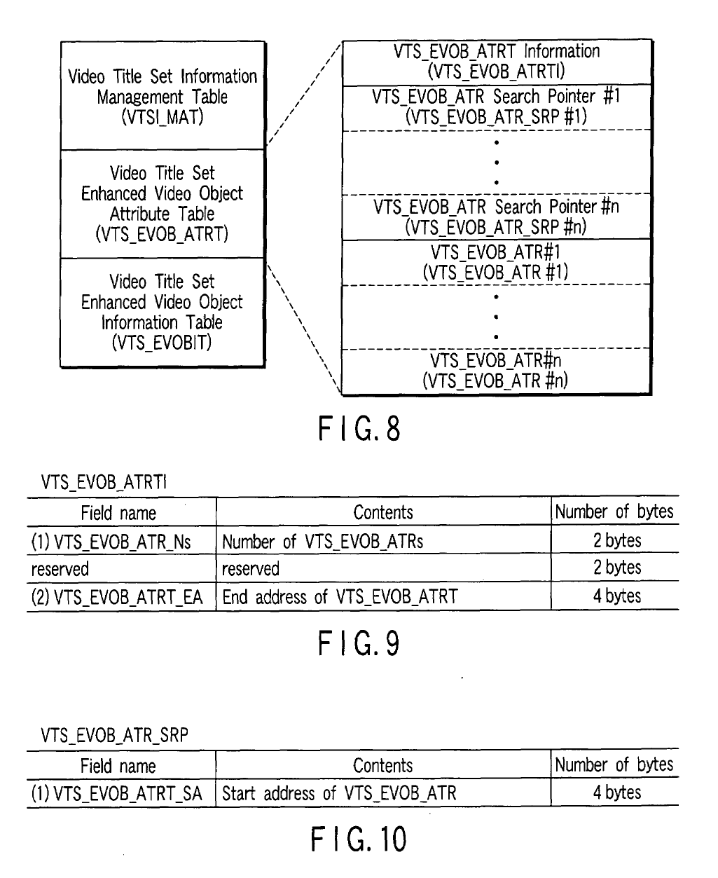

The Video Title Set Enhanced Video Object Attribute Table (VTS_EVOB_ATRT) is a table in which the attribute information defined in every EVOB under the primary video set shall be described. As shown in FIG. 8, the VTS_EVOB_ATRT starts with VTS_EVOB_ATRT Information (VTS_EVOB_ATRTI), followed by search pointer for each VTS_EVOB_ATR (VTS_EVOB_ATR_SRP #1 to #n) and actual individual Video Title Set Enhanced Video Object Attributes (VTS_EVOB_ATR #1 to #n) in that order.

As shown in FIG. 9, in the VTS_EVOB_ATRT Information (VTS_EVOB_ATRTI), VTS_EVOB_ATR_Ns placed first in a relative byte position (RBP) describes the number of VTS_EVOB_ATR. Next, VTSI_EVOB_ATRT_EA describes the end address of the VTS_EVOB_ATRT with a relative block number from the first byte of this VTS_EVOB_ATRT.

As shown in FIG. 10, VTS_EVOB_ATR Search Pointer (VTS_EVOB ATR_SRP) describes the start address of VTS_EVOB_ATR which corresponds to this EVOB with a relative block number from the first byte of this VTS_EVOB_ATRT.

The Video Title Set Enhanced Video Object Attribute (VTS_EVOB_ATR) corresponds to the attribute of one or more EVOBs in Primary Video Set. As shown in FIG. 11, in the VTS_EVOB_ATR, the following are arranged in relative byte positions RBP) in this order: EVOB type (EVOB_TY), Main Video Attribute of EVOB (EVOB_VM_ATR), Sub Video Attribute of EVOB (EVOB_VS_ATR), Luma value for Sub Video of EVOB (EVOB_VS_LUMA), Number of Main Audio streams of EVOB (EVOB_AMST_Ns), Main Audio Stream Attribute Table of EVOB (EVOB_AMST_ATRT), Down-mix coefficient table for Audio streams of EVOB (EVOB_DM_COEFTS), Number of Sub Audio streams of EVOB (EVOB_ASST_Ns), Sub Audio streams attribute table of EVOB (EVOB_ASST_ATRT), Number of Sub-picture streams of EVOB (EVOB_SPST_Ns), Sub-picture streams attribute table of EVOB (EVOB_SPST_ATRT), Sub-picture palette for SD of EVOB (EVOB_SDSP_PLT), Sub-picture palette for HD of EVOB (EVOB_HDSP_PLT), and others.

As shown in FIG. 12, the EVOB type (EVOB_TY) describes the existence of Sub Video stream, Sub Audio streams, and Advanced stream. Specifically, when Advanced stream existence allocated to bit 13 and bit 12 is “00b,” this means that Advanced stream doesn't exist in this EVOB. When it is “01b,” this means that Advanced stream exists in this EVOB. Similarly, when Sub Video existence allocated to bit 11 and bit 10 is “00b,” this means that Sub Video doesn't exist in this EVOB. When it is “01b,” this means that Sub Video exists in this EVOB. Still similarly, when Sub Audio existence allocated to bit 9 and bit 8 is “00b,” this means that Sub Audio doesn't exist in this EVOB. When it is “01b,” this means that Sub Audio exist in this EVOB. When the respective allocated bits take values other than the above values, they are reserved for other purposes.

The Main Video Attribute of EVOB (EVOB_VM_ATR) describes Main Video Attribute of an EVOB. The Sub Video Attribute of EVOB (EVOB_VS_ATR) describes Sub Video Attribute of an EVOB. The Luma value for Sub Video of EVOB (EVOB_VS_LUMA) describes range of Luma Key Function (Y) for Sub Video of EVOB.

The Number of Main Audio streams of EVOB (EVOB_AMST_Ns) describes the number of Main Audio streams in an EVOB as shown in FIG. 13. Specifically, Number of Audio streams allocated to bit 3 to bit 0 describes the numbers between 0 and 8. The other bits are reserved.

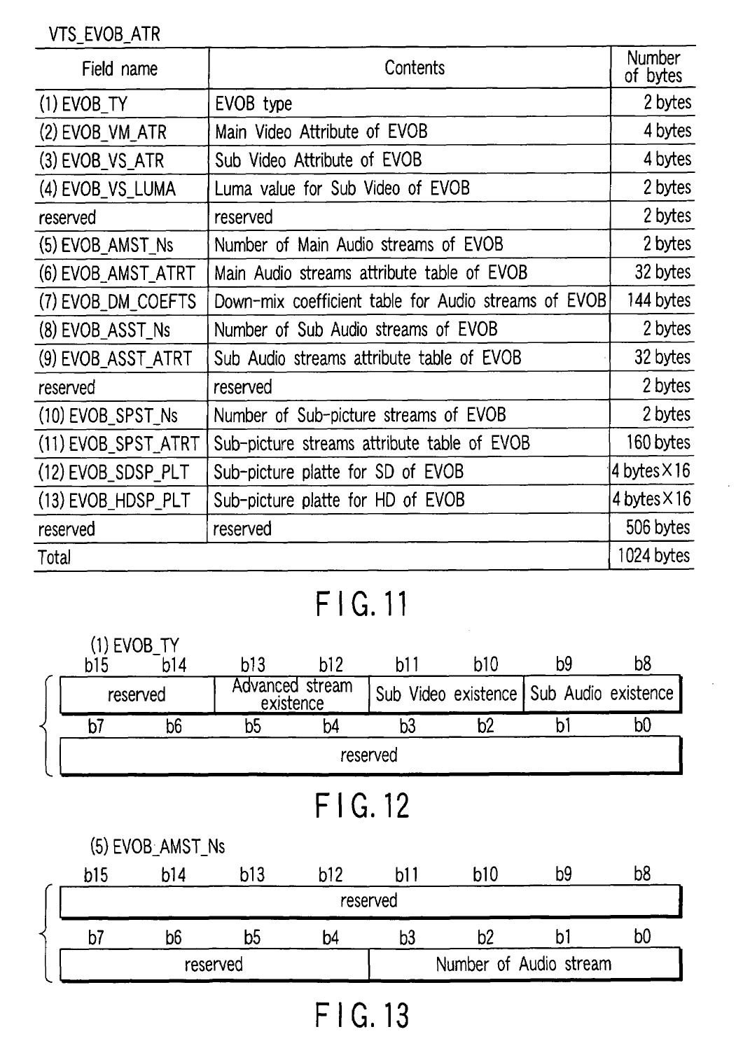

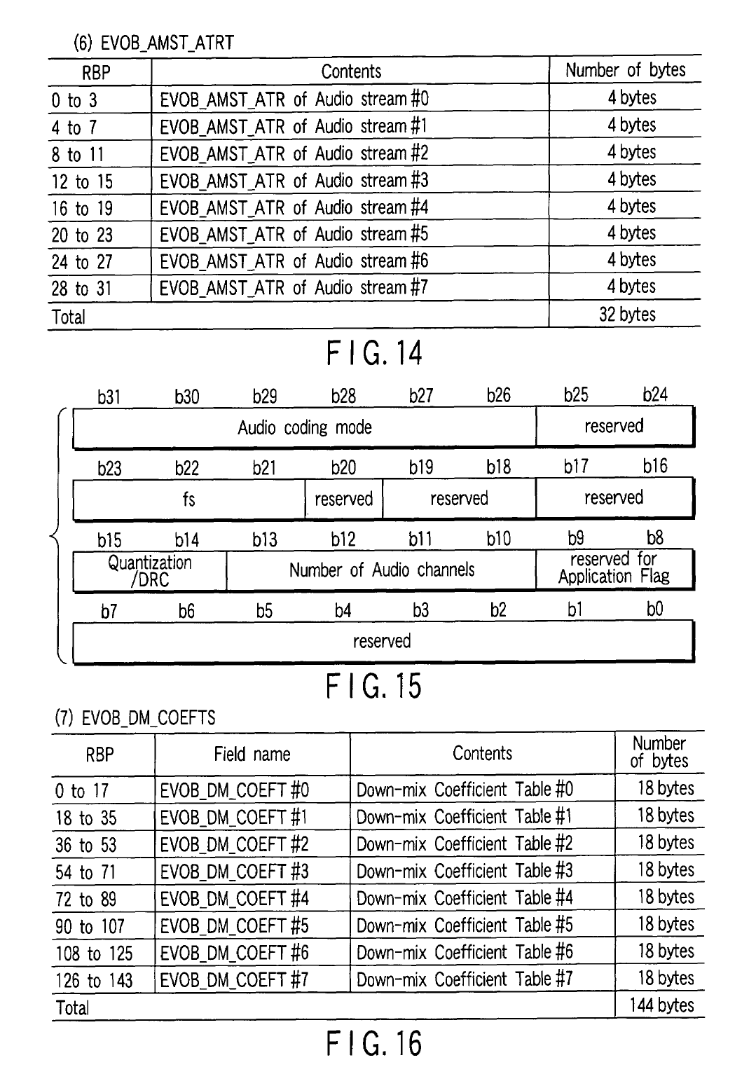

The Main Audio Stream Attribute Table of EVOB (EVOB_AMST_ATRT) describes the each Main Audio attributes of an EVOB as shown in FIG. 14. One EVOB_AMST_ATR is described for each Main Audio stream. There shall be area for eight EVOB_AMST_ATRs constantly. The stream numbers are assigned from 0 according to the order in which EVOB_AMST_ATRs are described. When the number of Main Audio streams are less than 8, fill “0b” in every bit of EVOB_AMST_ATR for unused streams.

The contents of one EVOB_AMST_ATR are as shown in FIG. 15. Specifically, in Audio coding mode allocated to bit 31 to 26, “000000b” is entered when the mode is reserved for Dolby AC-3 in Interoperable VTS, “000001b” is entered when the mode is MLP audio, “000010b” is entered when the mode is MPEG-1 or MPEG-2 without extension bitstream, “000011b” is entered when the mode is MPEG-2 with extension bitstream, “000100b” is entered when the mode is reserved for Linear PCM audio with sample data of 1/600 second in Interoperable VTS, “000101b” is entered when the mode is Linear PCM audio with sample data of 1/1200 second, “000110b” is entered when the mode is DTS-HD, and “000111b” is entered when the mode is Dolby Digital plus (DD+). In other cases, the bits are reserved.

In fs allocated to bit 23 to bit 21, “000b” is entered in the case of 48 kHz, “001b” is entered in the case of 96 kHz, and “010b” is entered in the case of 192 kHz. In other cases, the bits are reserved.

Quantization/DRC allocated to bit 15 and bit 14 fill with “11b” when the Audio coding mode allocated to bit 31 to bit 26 is “000000b,” “000110b,” or “000111b.” In contrast, when the Audio coding mode allocated to bit 31 to bit 26 is “000010b” or “000011b,” then the Quantization/DRC is defined as follows. When Dynamic range control (DRC) data do not exist in MPEG audio stream, “00b” is entered. When DRC data exists in the MPEG audio stream, “01b” is entered. “10b” and “11b” are reserved. When the Audio coding mode allocated to bit 31 to bit 26 is “000001b,” “000100b,” or “000101b,” then the Quantization/DRC is defined as follows. “00b” is entered in the case of 16 bits, “01b” is entered in the case of 20 bits, and “10b” is entered in the case of 24 bits. “11b” is reserved.

In Number of Audio channels allocated to bit 13 to bit 10, “0000b” is entered when the Number of Audio channels is 1ch (mono), “0001b” is entered when the number is 2ch (stereo), “0010b” is entered when the number is 3ch (multichannel), “0011b” is entered when the number is 4ch (multichannel), “0100b” is entered when the number is 5ch (multichannel), “0101b” is entered when the number is 6ch (multichannel), “0110b” is entered when the number is 7ch (multichannel), “00111b” is entered when the number is 8ch (multichannel), “1001b” is entered when the number is reserved for 2ch (dual monaural) in Interoperable VTS. In other cases, the bits are reserved. Here, “0.1ch” is defined as “1ch” (for example, “0101b” (6ch) is entered for 5.1ch). Moreover, the field of reserved for Application Flag allocated to bit 9 and bit 8 is reserved for Interoperable VTS.

As shown in FIG. 16, the Down-mix coefficient table for Audio streams of EVOB (EVOB_DM_COEFTS) describes the coefficients to mix down the audio data from multi-channel to 2-channel when this EVOB includes multi-channel Linear PCM audio data. If this EVOB does not include multi-channel Linear PCM audio data, every bit of all EVOB_DM_COEFTs is filled with “0b.” There shall be the area for eight EVOB_DM_COEFT #0 to EVOB_DM_COEFT #7 constantly. When the number of the coefficient tables is less than 8, every bit of unused EVOB_DM_COEFT is filled “0b.”

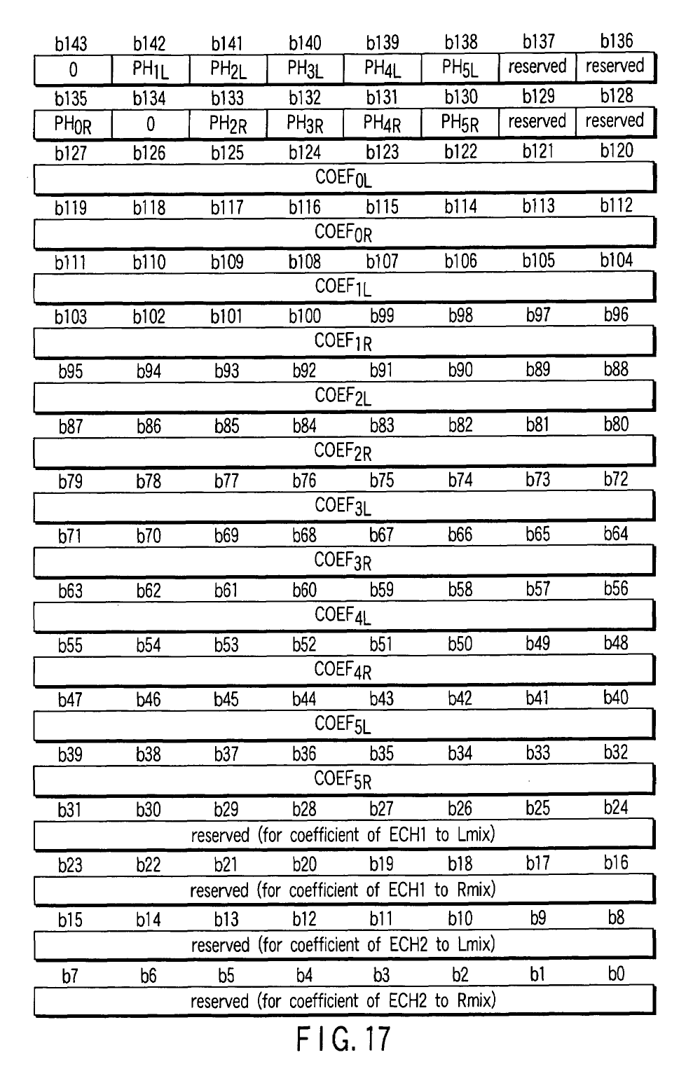

The contents of one EVOB_DM_COEFT are as shown in FIG. 17. In PH_{1L} (mixing phase of Rf to Lmix), PH_{2L} (mixing phase of C to Lmix), PH_{3L} (mixing phase of Ls(/S) to Lmix), PH_{4L} (mixing phase of Rs to Lmix), and PH_{5L} (mixing phase of LFE to Lmix) allocated to bit 142 to bit 138, the mixing phases of the signals allocated to Rf, C, Ls(/S), Rs, and LFE to produce the signal Lmix are described respectively. When mixing is to be done in phase, “0b” is entered. When mixing is to be done out of phase, “1b” is entered. Bit 137 and bit 136 are reserved for the future expansion of the channels defined as ECH1 and ECH2.

In PH_{1R} (mixing phase of Lf to Rmix), PH_{2R} (mixing phase of C to Rmix), PH_{3R} (mixing phase of Ls(/S) to Rmix), PH_{4R} (mixing phase of Ls to Rmix), and PH_{5R} (mixing phase of LFE to Rmix) allocated to bit 135, bit 133 to bit 128, the mixing phases of the signals allocated to Lf, C, Ls(/S), Rs, and LFE to produce the signal Rmix are described respectively. When mixing is to be done in phase, “0b” is entered. When mixing is to be done out of phase, “1b” is entered. Bit 129 and bit 128 are reserved for the future expansion of the channels defined as ECH1 and ECH2.

In COEF_{0L} (coefficient of Lf to Lmix) allocated to bit 127 to bit 120, COEF_{1L} (coefficient of Rf to Lmix) allocated to bit 111 to bit 104, COEF_{2L} (coefficient of C to Lmix) allocated to bit 95 to bit 88, COEF_{3L} (coefficient of Ls(/S) to Lmix) allocated to bit 79 to bit 72, COEF_{4L} (coefficient of Rs to Lmix) allocated to bit 63 to bit 56, and COEF_{5L} (coefficient of LFE to Lmix) allocated to bit 47 to bit 40, the mixing phases of the signals allocated to Lf, Rf, C, Ls(/S), Rs, and LFE to produce the signal Lmix are described respectively.

In COEF_{0R} (coefficient of Lf to Rmix) allocated to bit 119 to bit 112, COEF_{1R} (coefficient of Rf to Rmix) allocated to bit 103 to bit 96, COEF_{2R} (coefficient of C to Rmix) allocated to bit 87 to bit 80, COEF_{3R} (coefficient of Ls(/S) to Rmix) allocated to bit 71 to bit 64, COEF_{4R} (coefficient of Rs to Rmix) allocated to bit 55 to bit 48, and COEF_{5R} (coefficient of LFE to Rmix) allocated to bit 39 to bit 32, the mixing phases of the signals allocated to Lf, Rf, C, Ls(/S), Rs, and LFE to produce the signal Rmix are described respectively.

The reserved bytes in this table are for the future expansion of the channels defined as ECH1 and ECH2.

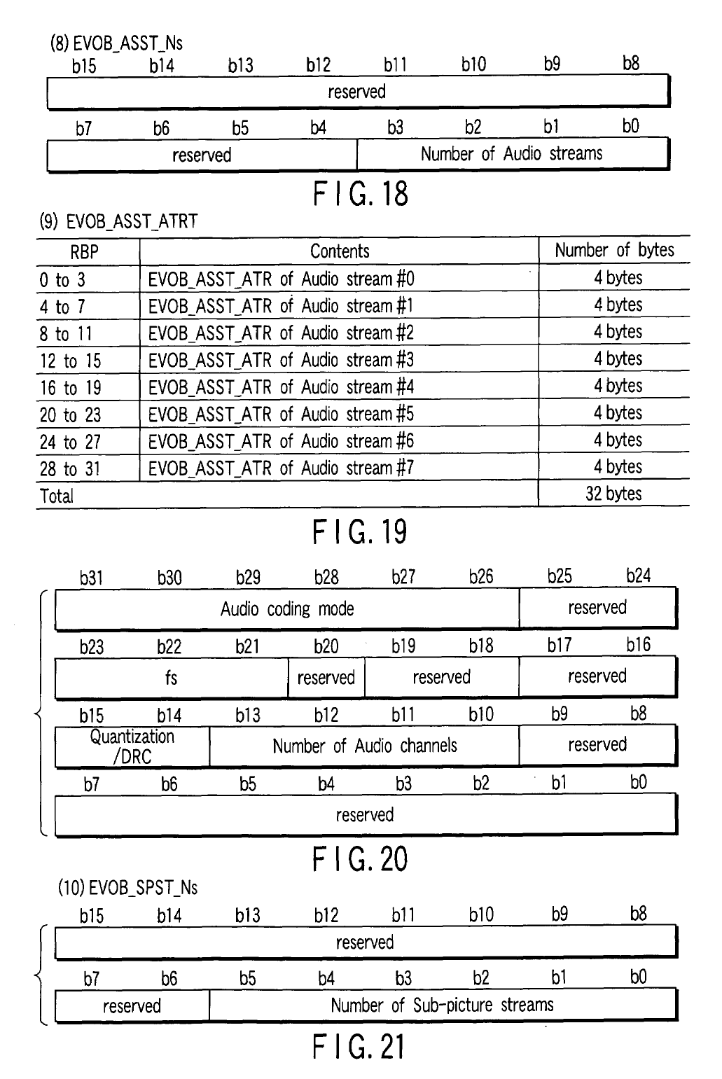

The Number of Sub Audio streams of EVOB (EVOB_ASST_Ns) describes the number of Sub Audio streams in an EVOB as shown in FIG. 18. Specifically, Number of Audio streams allocated to bit 3 to bit 0 describes the numbers between 0 and 8. The other bits are reserved.

The Sub Audio streams attribute table of EVOB (EVOB_ASST_ATRT) describes the each Sub Audio attribute of an EVOB as shown in FIG. 19. One EVOB_ASST_ATRT is described for each Sub Audio stream. There shall be area for eight EVOB_ASST_ATRT #0 to EVOB_ASST_ATRT #7 constantly. When the number of Sub Audio streams is less than 8, every bit of EVOB_ASST_ATRT for unused streams is filled with “0b.”

The contents of one EVOB_ASST_ATRT are as shown in FIG. 20. In Audio coding mode allocated to bit 31 to bit 26, “000110b” is entered when the mode is DTS-HD, “000111b” is entered when the mode is Dolby Digital plus (DD+), “100000b” is entered when the mode is mp3 (optional), “100001b” is entered when MPEG-4 HE AAC v2 (optional), and “100010b” is entered when the mode is WMA Pro (optional). In other cases, the bits are reserved.

In fs allocated to bit 23 to bit 21, “000b” is entered in the case of 48 kHz, “100b” is entered in the case of 12 kHz, and “101b” is entered in the case of 24 kHz. In other cases, the bits are reserved. In Quantization/DRC allocated to bit 15 and bit 14, “11b” is set when the Audio coding mode allocated to bit 31 to bit 26 is “000110b,” “000111b,” “100000b,” “100001b,” or “100010b.” In Number of Audio channels allocated to bit 13 to bit 10, “0000b” is entered when the Number of Audio channels is lch (mono) and “0001b” is entered when the number is 2ch (stereo). In other cases, the bits are reserved.

The Number of Sub-picture streams of EVOB (EVOB_SPST_Ns) describes the number of Sub-picture streams of an EVOB as shown in FIG. 21. Number of Sub-picture streams allocated to bit 5 to bit 0 describes the number between 0 and 32. In other cases, the bits are reserved.

The Sub-picture streams attribute table of EVOB (EVOB_SPST_ATRT) describes each Sub-picture stream attribute (EVOB_SPST_ATR) for an EVOB. The Sub-picture palette for SD of EVOB (EVOB_SDSP_PLT) describes 16 sets of luminance signal and two Color difference signals commonly used in all of the Sub-picture streams for SD (2 bits/pixel) in an EVOB. The Sub-picture palette for HD of EVOB (EVOB_HDSP_PLT) describes 16 sets of luminance signal and two Color difference signals commonly used in all of the Sub-picture streams for HD (2 bits/pixel) in this EVOB.

In the Video Title Set Enhanced Video Object Information Table (VTS_EVOBIT), the information for every EVOB under the Primary Video Set shall be described.

Although neither illustrated nor explained, Secondary Video Set, Advanced Application, and Advanced Substitute are written using a configuration similar to that of the Primary Video Set.

The moving image reproducing apparatus 10 of the embodiment can reproduce data using a wide variety of functions under various conditions.

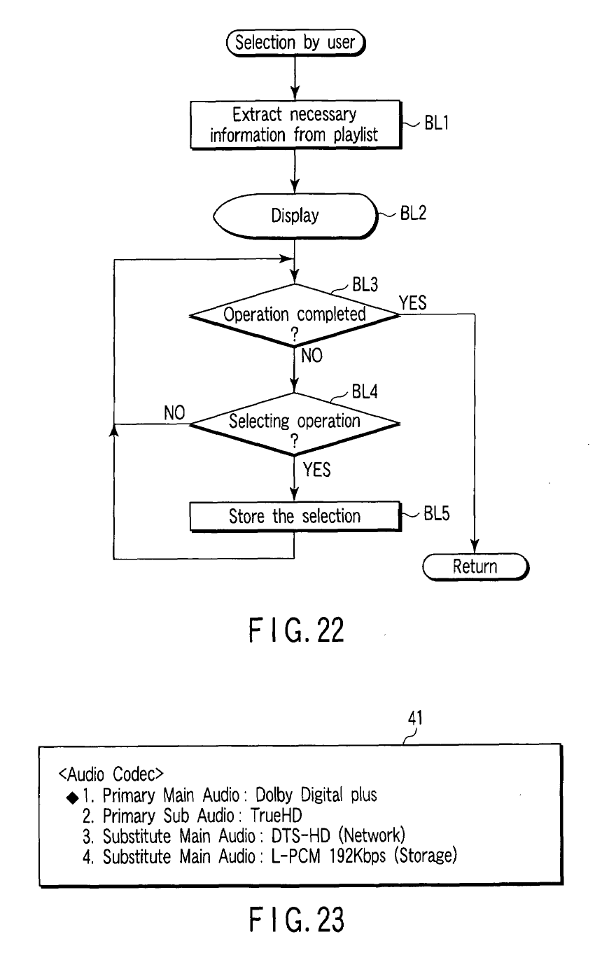

The MPU 114 of the moving image reproducing apparatus 10 of the embodiment carries out a user selecting process as shown in FIG. 22 according to a control program stored in a ROM section 116 when the disc 1 is loaded in the moving image reproducing apparatus 10 or in response to a specific menu selecting operation by the user using a key input section 115 in the middle of reproducing moving images.

The MPU section 114 reads the configuration of a plurality of streams constituting the content recorded in the disc 1 and extracts the necessary information on the basis of the Playlist recorded in the disc 1 or already read from the disc 1 and stored in a memory section 105 or the like (block BL1). Then, from the extracted information, a video signal for displaying a selection window 41 as shown in FIG. 23 on an image display unit (not shown) is generated and output via a video processor section 111 and a D/A converting section 112 to the image display unit (block BL2).

Specifically, in the block BL1, the MPU section 114 refers to the description at the tag part, such as “<PrimaryAudioVideoClip id=“***”” or “<SubstituteAudioClip id=“***”” as shown in FIG. 6 and further such a description as the existence of Sub Audio of the EVOB type (EVOB_TY) and the description of the Audio coding mode of the EVOB_AMST_ATR or EVOB_ASST_ATR about a file specified by such a file name as “src=“file:///dvddisc/HDDVD_TS/TITLE001.MAP”” and then extracts and displays the described information.

FIG. 23 is an exemplary diagram showing a case where there are Primary Main Audio stream and Primary Sub Audio stream on the disc 1, the Primary Main Audio steam is compressed with Dolby Digital plus Audio CODEC, and the Primary Sub Audio stream is compressed with True HD Audio CODEC, and where there is Substitute Main Audio stream on the network server 2 and there is Substitute Main Audio stream on the storage medium 3, the Substitute Main Audio stream on the network server 2 is compressed with DTS-HD Audio CODEC, the Substitute Main Audio stream on the storage medium 3 is compressed with L-PCM 192-kbps Audio CODEC.

This example has shown the case where there is an Audio stream on each of the network server 2 and storage medium 3. There may be a case where none of them exist or where an Audio stream exists on only either the network server 2 or the storage medium 3. Alternatively, there may be a case where Sub Audio exists instead of the Main audio. Where such an Audio stream outside the disc 1 exists can be known from the description of “dataSource=” in the Playlist.

As described above, for example, the Primary Video Set can hold eight Main Audio streams and eight Sub Audio streams. If there is a Main Audio stream using a different Audio CODEC, a plurality of Primary Main Audio streams are displayed in the selection window 41 to enable each Audio CODEC to be selected. Even if the Main Audio streams use the same Audio CODEC, they may differ in the sampling frequency fs or in quantization/DRC. In such a case, too, a plurality of Primary Main Audio streams are displayed. The same holds true for other Audio streams.

Then, after having displayed such selection window 41, the MPU section 114 waits for a specific end operation (block BL3) or the selection of an Audio CODEC to be used (block BL4) by user.

After the Audio CODEC has been selected (block BL4), the MPU section 114 stores the selection into the memory section 105 (block BL5). Thereafter, the MPU selection 114 returns to block BL3, waiting for the user's next operation.

After the end operation is selected by user (block BL3), the user selecting operation is ended. Then, moving images are reproduced using the Audio CODEC according to the selection stored in the memory section 105.

As described above, according to what has been written in the Playlist, the configurations of a plurality of Audio CODECs in a plurality of audio streams and the setting of each Audio CODEC included in the content are read and shown to the user in an easy-to-understand manner, which enables the user to make a selection easily.

Hereinafter, using concrete examples of use, the operation of the moving image reproducing apparatus 10 of the embodiment will be explained.

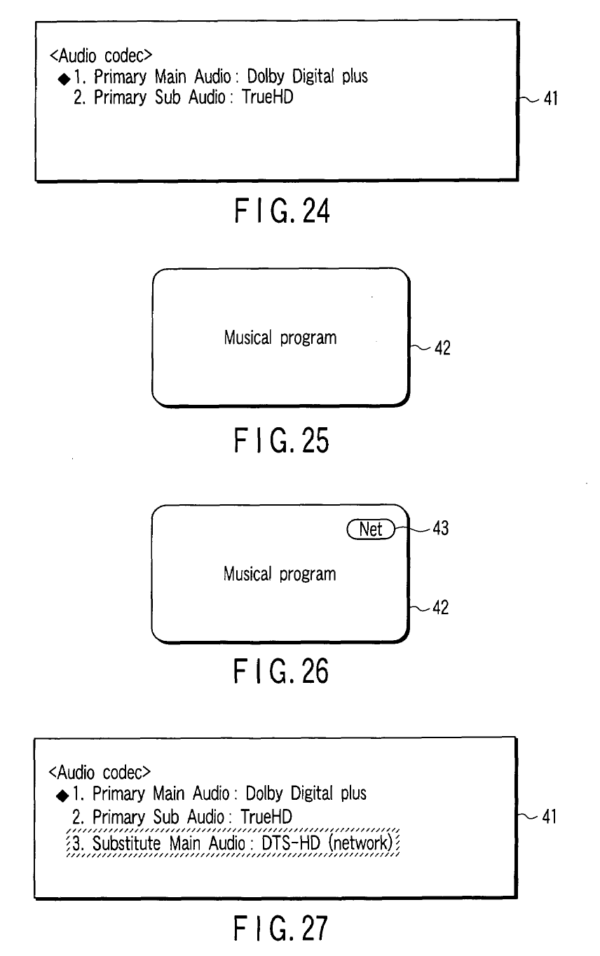

FIG. 24 is an exemplary diagram showing the selection window 41 appearing when a disc 1 is loaded in which only the images and sound of musical programs have been recorded as Primary Audio/Video. In this case, it is possible to select a Primary Main Audio stream using the Dolby Digital plus Audio CODEC and a Primary Sub Audio stream using the True HD Audio CODEC included in the Primary Audio/Video. When the user selects either of them, the selected Audio stream is reproduced. In this case, on the main screen 42 of the image display unit, a musical program is displayed as shown in FIG. 25.

The streams on the network server 2 can be updated as needed. Therefore, it is very important to the user to know whether the streams currently on the network server 2 have been updated, or whether the user has already listened to them.

Accordingly, the MPU section 114 periodically checks whether the streams on the network server 2 have been updated. It is desirable that, if they have been updated, an icon 43 informing the user of the update should be displayed in a specific position on the main screen 42 on which a musical program or the like is being displayed, thereby notifying the user of the update.

Then, according to the icon 43 on the screen, the user carries out a specific menu selecting operation using the key input section 115, thereby causing the MPU section 114 to carry out the user selecting process as explained in FIG. 22, which enables the user to select and listen the updated stream on the network server 2. In this case, for the user to distinguish the updated stream easily, it is more desirable that the stream (or the Substitute Main Audio stream using the DTS-HD Audio CODEC) should be highlighted in the selection window 41 as shown in FIG. 27.

Of course, the icon 43 may be made displayable or undisplayable by selection or the updated stream may be or may not be highlighted by selection.

In the above embodiment, the configurations of a plurality of Audio CODECs in a plurality of Audio streams and the setting of each Audio CODEC have been extracted from the Playlist according to a specific menu selecting operation by the user using the key input section 115 in the middle of reproducing moving images. However, the configurations of a plurality of Audio CODECs in a plurality of Audio streams multiplexed on the Timeline and the setting of each Audio CODEC may be extracted in advance in the middle of reproduction and they may be displayed according to a specific menu selecting operation by the user.

Furthermore, the above embodiment may be applied to the reproducing system or recording and reproducing system of the next-generation HD-DVD which will come into wide use shortly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A moving image reproducing apparatus which reproduces content including a plurality of streams compressed according to a plurality of CODECs, the moving image reproducing apparatus comprising:
an extracting section which extracts configurations of a plurality of Audio CODECs in a plurality of audio streams and a setting of each Audio CODEC included in content;
a display section which generates and outputs a display signal for displaying in list form the configurations of the plurality of Audio CODECs and the setting of each Audio CODEC extracted by the extracting section;
an input section which receives a selection of a set of an audio stream, an Audio CODEC, and a setting of the Audio CODEC by a selection on the list displayed; and
a reproducing section which carries out a reproducing operation according to the selection of the set received by the input section.

2. The moving image reproducing apparatus according to claim 1, wherein the content includes an audio stream on a disc and an audio stream on at least one of a network and a storage medium, and
the extracting section extracts the configurations of a plurality of Audio CODECs and the setting of each Audio CODEC in the audio stream on the disc and in the audio streams on at least one of the network and the storage medium.

3. The moving image reproducing apparatus according to claim 2, wherein the display section generates and outputs a display signal for displaying in list form the configurations of the plurality of Audio CODECs in the plurality of audio streams and the setting of each Audio CODEC extracted by the extracting section, including information as to which one of the disc, network, and storage medium they have been extracted from.

4. The moving image reproducing apparatus according to claim 1, further comprising an informing section which notices an update, when any one of the audio streams in the content has been updated in the middle of reproducing the content at the reproducing section.

5. A moving image reproducing apparatus which reproduces content including a plurality of streams compressed according to a plurality of CODECs, the moving image reproducing apparatus comprising:
a reproducing section which reproduces content;
an extracting section which extracts configurations of a plurality of Audio CODECs in a plurality of audio streams and a setting of each Audio CODEC included in the content in the middle of reproducing the content by the reproducing section;
an instruction input section which receives a display instruction to display information extracted by the extracting section;
a display section which, according to the display instruction by the instruction input section, generates and outputs a display signal for displaying in list form the configurations of the plurality of Audio CODECs in the plurality of audio streams and the setting of each CODEC extracted by the extracting section;
an input section which receives a selection of a set of an audio stream, an Audio CODEC, and a setting of the Audio CODEC by a selection on the list displayed; and
a control section which causes the reproducing section to carry out a reproducing operation according to the selection of the set received by the input section.

6. The moving image reproducing apparatus according to claim 5, wherein the content includes an audio stream on a disc and an audio stream on at least one of a network and a storage medium, and
the extracting section extracts the configurations of a plurality of Audio CODECs and the setting of each Audio CODEC in the audio stream on the disc and in the audio streams on at least one of the network and the storage medium.

7. The moving image reproducing apparatus according to claim 6, wherein the display section generates and outputs a display signal for displaying in list form the configurations of the plurality of Audio CODECs in the plurality of audio streams and the setting of each Audio CODEC extracted by the extracting section, including information as to which one of the disc, network, and storage medium they have been extracted from.

8. The moving image reproducing apparatus according to claim 5, further comprising an informing section which notices an update, when any one of the audio streams in the content has been updated in the middle of reproducing the content at the reproducing section.

9. A moving image reproducing method of reproducing content including a plurality of streams compressed according to a plurality of CODECs, the moving image reproducing method comprising:
extracting configurations of a plurality of Audio CODECs in a plurality of audio streams and a setting of each Audio CODEC included in content;
generating and outputting a display signal for displaying in list form the configurations of the plurality of Audio CODECs and the setting of each Audio CODEC in the plurality of extracted audio streams;
receiving a selection of a set of an audio stream, an Audio CODEC, and a setting of the Audio CODEC by a selection on the list displayed; and
carrying out a reproducing operation according to the received selection of the set.

10. The moving image reproducing method according to claim 9, further comprising noticing an update, when any one of the audio streams in the content has been updated in the middle of reproducing the content.
